(19) United States
(12) Patent Application Publication
(10) Pub. No.: US 2007/0009781 A1
(43) Pub. Date: Jan. 11, 2007

(54) Flow field plates for fuel cells

(75) Inventor: Junqing Dong, Shenzhen (CN)

Correspondence Address: EMIL CHANG;LAW OFFICES OF EMIL CHANG, 874 JASMINE DRIVE, SUNNYDALE, CA, 94086, US

(73) Assignee: BYD Company Limited

(21) Appl. No.: 11/391,611

(22) Filed: Mar. 27, 2006

(30) Foreign Application Priority Data
Jul. 8, 2005 (CN) 200510066311.9

(51) Int. Cl. H01M 8/02

(52) U.S. Cl. 429/38

(57) ABSTRACT

This invention relates to a type of flow field plate for fuel cells. The flow field plates include cathode flow field plates and anode flow field plates. There are one or more flowpaths, gas entrances and gas exits on both the cathode and anode flow field plates. One end of the flowpath is connected to the gas entrance, and the other end is connected to the gas exit. Here, on the cathode and/or anode flow field plates, the cross-sectional area of the flowpath at the gas entrance is larger than the cross-sectional area of the flowpath at the gas exit. By increasing the cross-sectional area of the flowpath at the gas entrance, the flow field plates of this invention effectively reduce the loss of water by the proton-exchange membranes, thereby enhancing the electricity generation properties of fuel cells. Meanwhile, by reducing the cross-sectional area of the flowpath at the gas exits, the ability of the flowpath to drain water is enhanced, effectively preventing water from accumulating in the flowpath and thereby improving the stability, reliability, and performance of the cell.

### CROSS REFERENCE

This application claims priority from a Chinese patent application entitled “Flow Field Plates for Fuel Cells” filed on Apr. 22, 2005, having a Chinese Application No. 200510066311.9. This application is incorporated herein by reference in its entirety.

### FIELD OF INVENTION

This invention relates to the field of fuel cells, and, in particular, it relates to flow field plates for fuel cells.

### BACKGROUND

Fuel cells with proton-exchange membranes are a type of highly efficient and environment-friendly energy conversion device. They have advantages including high power densities, rapid startup at normal temperatures, lack of electrolyte loss, etc. They are very suitable for being the electrical sources for electric cars, mobile power sources, and small decentralized electricity generating systems. They use the proton-exchange membranes as the electrolyte, pure hydrogen or hydrogen-rich gas (generally referring to a hydrogen-rich gas mixture generated in the reforming reactions of carbon-hydrogen compounds; containing a certain amount of CO₂ and CO) as the fuel, and air or pure oxygen as the oxidant. The product of the reactions is water. The chemical reactions of the cells are as follows:
Anode: H₂−2e=2H⁺
Cathode: 1/2O₂+2H⁺+2e=H₂O
Total reaction: H₂+1/2O₂=H₂O

Fuel cells with proton-exchange membranes mainly comprise of membrane electrode assemblies and flow field plates. As shown in FIG. 1, a membrane electrode assembly comprises of a proton-exchange membrane 3, a cathode gas-diffusion layer 4, an anode gas-diffusion layer 5, a cathode catalyst layer 6 and an anode catalyst layer 7. The flow field plates comprise of a cathode flow field plate 1 and an anode flow field plate 2. The membrane electrode assembly is the location where the reactions of the cell take place. The flow field plates provide the channels for the reacting gases and products of the reactions to enter and exit the reaction areas, and electricity is generated by the reactions.

The sides facing the membrane electrode assembly on the cathode flow field plate 1 and the anode flow field plate 2 are respectively engraved with a flowpath 8, i.e., the flow fields. The function of the flowpaths is to distribute the reacting gases, and to release the water and gas waste generated by the reactions. Generally, since the amount of gas flow on the anode flow field plate 2 is smaller than the amount of gas flow on the cathode flow field plate 1, and the amount of water in the gas waste is smaller than that of the latter, the number of parallel channels in the anode flow field plate 2 is smaller than that of the cathode flow field plate 1. Generally, given a certain amount of fuel cell gas flow, the number of parallel channels and the size of their cross sectional area directly determine the flowing speed of the reacting gases and their flowing modes, affecting the speed of dispersion of the reacting gases and the water product within the membrane electrode assembly and the balance of water in the proton-exchange membrane. Therefore, they have a great influence on the properties of the fuel cells.

It is well-known that water must be involved in the process of conducting protons through the proton-exchange membranes. Water is either generated in the internal reactions of the fuel cells or by humidifying the reacting gases outside the cells. If the proton-exchange membrane is too dry, proton conduction will be difficult, and the properties of the cells will worsen and the cells may even fail to generate electricity. On the other hand, if there is an excessive amount of water on the proton-exchange membranes, too much water will accumulate in the flowpath of the cathode flow field plate, hindering the flow of the reacting gases and the affecting properties of the cell. Therefore, keeping the proton-exchange membrane properly humidified is very important for fuel cells.

However, the flowpaths of the flow field plates of the current fuel cells have the disadvantages including that the proton-exchange membrane at the entering portion (i.e., the entering area at the gas entrance making up 10%-15% of the total surface area of the flowpaths, same as described below) is too dry, causing protons conduction to be difficult. While the end portion (i.e., the end area at the gas exit making up 10%-50% of the total surface area of the flowpaths, same as described below) has an excessive amount of water, causing the flowpaths to be prone to water accumulation. Consequently, the electricity generation properties at the entering portion area will be bad and a large amount of aqueous liquid will emerge at the end portion area, hindering the normal passage of the reacting gases, and lowering the electricity generation properties, stability and reliability of the fuel cells.

### SUMMARY OF THE INVENTION

An object of this invention is to facilitate better flow with the flowpaths of the flow field plates.

Another object of the invention is to control water accumulation of the flowpaths of the flow field plates.

Briefly, a presently preferred embodiment of this invention provides a type of flow field plate for fuel cells. Said flow field plates can include a cathode flow field plate 1 and an anode flow field plate 2, a flowpath 8 respectively located on the cathode flow field plate 1 and the anode flow field plate 2, a gas entrance 9, a gas exit 10 and plate ribs 11. One end of the flowpath 8 is connected to the gas entrance 9, and the other end is connected to the gas exit 10. Here, the cross-sectional area of the flowpath of cathode flow field plate 1 and/or the flowpath of the anode flow field plate 2 at the gas entrances is larger than the cross-sectional area of the flowpaths at the gas exits.

An advantage of this invention is that by increasing the cross-sectional area of the flowpaths at the gas entrance, the flow field plates of this invention control the flow of the reacting gases.

Still another advantage of this invention is that without changing the humidifying conditions, this invention effectively reduces the loss of water by the proton-exchange membranes, thereby improving the electricity generation properties of the fuel cells.

Still yet another advantage of this invention is that by reducing the cross section of the flowpaths at the gas exit, the flow field plates of this invention allow the reacting gases to speed up, thereby improving the ability of the flowpaths to drain water, effectively preventing water from accumulating in the flowpaths, and thereby improving the stability and reliability of the fuel cells.

### FIGURES

The following are further descriptions of the invention with references to figures and examples of their applications.

FIG. 1 is an illustration of a prior art fuel cell unit;

FIG. 2 is an illustration of a structure of the flow field plate of Embodiment 1 with a flowpath having a varied width;

FIG. 3 is an illustration of a structure of the flow field plate of Embodiment 2 with a flowpath having a varied depth;.

FIG. 4 is an illustration of a structure of cathode flow field plate 1 of Embodiment 3; and

FIG. 5 is an illustration of a structure of anode flow field plate 2 of Embodiment 3.

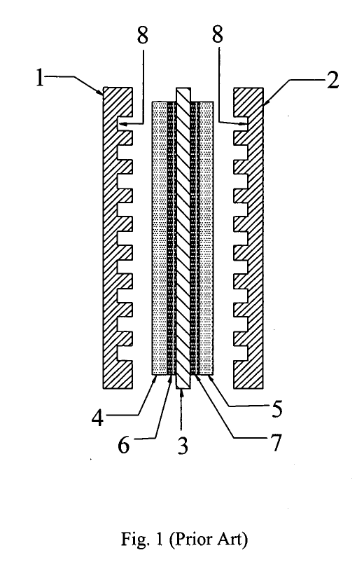

### DETAILED DESCRIPTION OF THE PREFERRED EMBODIMENTS

Through research, the inventor has discovered that current flowpaths in flow field plates are generally evenly distributed single channel or parallel multiple channels, and the number, width and depth of channels of the entering portion and the end portion are identical. However, before the reacting gases enter the flowpath, their humidity is generally low. Even if the reacting gases have been pre-humidified before entering the flowpaths, their relative humidity will not reach saturation. Otherwise, the amount of water at the exits will be excessively large and flooding can easily occur. Therefore, the entering portion of the flowpath at the gas entrances is relatively dry, causing the proton exchange membrane at that portion relatively dry, making it difficult to conduct protons, thus the electricity generating properties of that area is relatively poor. At the end portion of the flowpath at the gas exits, due to the accumulating of the water and humidifying effect, the reacting gases would contain a large amount of water. At the same time, if the reacting gases are relatively thoroughly pre-humidified or the amount of gas flow is relatively small, a large amount of aqueous liquid will accumulate at the end portion of the flowpaths. The water accumulation will hinder the normal passing through of the reacting gases, causing the electricity generating properties, stability and reliability of the fuel cells to be poor.

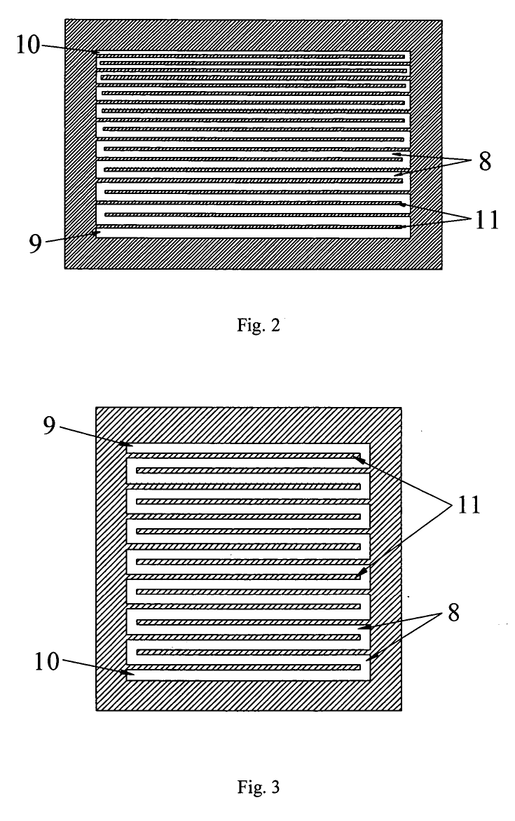

As shown in FIG. 2 and FIG. 3, the cathode flow field plate 1 and the anode flow field plate 2 for fuel cells of this invention respectively have a flowpath 8, a gas entrance 9, a gas exit 10 and plate ribs 11, and an end of the flowpath 8 is connected to the gas entrance 9, with the other end connected to the gas exit 10.

Here, the flow field plates can be made of various materials, such as graphite or corrosion-free metals. Said corrosion-free metals can be, for example, stainless steel, nickel, titanium, or gold. The flowpath 8 can be of various shapes, such as serpent-like or pectinate. Also, the cross section of the flowpath 8 can be of various shapes, such as rectangular or trapezoid.

On the flow field plates for fuel cells of preferred embodiments of this invention, the cross-sectional area of the flowpaths of the cathode flow field plate 1 and/or the anode flow field plate 2 at the gas entrance is larger than the cross-sectional area of the flowpaths at the gas exit.

Here, the reduction of the cross-sectional area of the flow paths of said cathode flow field plate 1 from the gas entrance to the gas exit can be done linearly or nonlinearly.

Linear reduction means the cross-sectional area of the flowpath gradually reduces in a linear fashion from the gas entrance to the gas exit.

Nonlinear reduction means the cross-sectional area of the flowpath gradually reduces in a nonlinear fashion from the gas entrance to the gas exit. In other words, the flowpath in the cathode flow field plate 1 is viewed as an entering portion, a middle portion (e.g., the middle area making up 10%-50% of the total length or area of the flowpath, same as follows), and an end portion. The cross-sectional area of the entering portion of the flowpath is equivalent to the cross-sectional area of the middle portion of the flowpath, and the cross-sectional area of the middle portion of the flowpath is larger than the cross-sectional area of the end portion of the flowpath. Alternatively, the cross-sectional area of the entering portion of the flowpath is larger than the cross-sectional area of the middle portion of the flowpath, and the cross-sectional area of the middle portion of the flowpath is larger than or equivalent to the cross-sectional area of the end portion of the flowpath. Nonlinear reduction can be implemented by separately or simultaneously changing the number of channels in the flowpath, or the width or depth of the flowpath thus changing the cross-sectional area of the flowpath. Generally, it can be implemented by the following methods:

One method is that the flowpath of said cathode flow field plate 1 comprises of single channels or parallel multiple channels, and the number of channels for the entering portion, middle portion and the end portion of the flowpaths are identical. The depth and/or width of the channels of the entering portion of the flowpaths are greater than the depth and/or width of the channels of the middle portion of the flowpath. The depth and/or width of the channels of the middle portion of the flowpath are greater than or equivalent to the depth and/or width of the channels of the end portion of the flowpath.

Another method is that the flowpath of said cathode flow field plate 1 comprises of single channels or parallel multiple channels, and the number of channels for the entering portion, middle portion and the end portion of the flowpaths are identical. The depth and/or width of the channels of the entering portion of the flowpath are equivalent to the depth and/or width of the-channels of the middle portion of the flowpath. The depth and/or width of the channels of the middle portion of the flowpath are greater than the depth and/or width of the channels of the end portion of the flowpath.

Still another method is that the flowpath of said cathode flow field plate 1 comprises of parallel multiple channels. The number of the channels for the entering portion of the flowpaths is greater than the number of the channels for the middle portion of the flowpath. The number of the channels for the middle portion of the flowpath is greater than or equivalent to the number of the channels for the end portion of the flowpath.

Still yet another method is that the flowpath of said cathode flow field plate 1 comprises of parallel multiple channels. The number of the channels for the entering portion of the flowpath is equivalent to the number of the channels for the middle portion of the flowpath. The number of the channels for the middle portion of the flowpath is greater than the number of the channels for the end portion of the flowpath.

Still yet another method is that the flowpath of said cathode flow field plate 1 comprises of parallel multiple channels. The number of the channels for the entering portion of the flowpath is greater than the number of the channels for the middle portion of the flowpath. The number of the channels for the middle portion of the flowpath is greater than or equivalent to the number of the channels for the end portion of the flowpath. Meanwhile, the depth and/or width of the channels for the entering portion of the flowpath are greater than the depth and/or width of the channels for the middle portion of the flowpath, and the depth and/or width of the channels for the middle portion of the flowpath are greater than or equivalent to the depth and/or width of the channels for the end portion of the flowpath.

Still yet another method is that the flowpath of said cathode flow field plate 1 comprises of parallel multiple channels. The number of the channels for the entering portion of the flowpath is equivalent to the number of the channels for the middle portion of the flowpath. The number of the channels for the middle portion of the flowpath is greater than the number of the channels for the end portion of the flowpath. Meanwhile, the depth and/or width of the channels for the entering portion of the flowpath are equivalent to the depth and/or width of the channels for the middle portion of the flowpath, and the depth and/or width of the channels for the middle portion of the flowpath are greater than the depth and/or width of the channels for the end portion of the flowpath.

Among the above embodiments, the ratio of the width of the channels of the entering portion of the flowpath, the width of the channels of the middle portion, and the width of the channels of the end portion can be 1: (0.4-1.0): (0.2-0.5); the ratio of the depth of the channels of the entering portion of the flowpaths, the depth of the channels of the middle portion, and the depth of the channels of the end portion can be 1: (0.5-1.0): (0.25-0.50).

Here, the width H of the channels can range from 0.2-6.0 mm, preferably 1.2-2.4 mm, and the depth W can range from 0.1-3.0 mm, preferably 0.3-1.0 mm. The number of parallel channels of the flowpath can range from 3-100, preferably 4-10.

Preferably, the entering portion of the flowpath in the cathode flow field plate 1 comprise of 2-10 parallel channels, the middle portion comprises of 1-4 parallel channels, and the end portion comprises of 1-2 channels.

Another preferred embodiment of this invention is, while varying the cross-sectional area of the flowpath in the cathode flow field plate 1, to simultaneously vary the cross-sectional area of the flowpath in the anode flow field plate 2. That means dividing the anode flow field plate 2 into an entering portion, a middle portion and an end portion. The flowpath comprises of parallel multiple channels. The number of the channels for the entering portion of the flowpath is greater than the number of channels for the middle portion of the flowpath. The number of the channels for the middle portion of the flowpath is greater than or equivalent to the number of the channels for the end portion of the flowpath. Preferably, the entering portion of the flowpath of the anode flow field plate 2 comprises of 2-4 parallel channels, and the middle portion and the end portion respectively comprises of 1-3 channels.

When the flow field plates for fuel cells of this invention are adopted, the fuel gases enter the flowpath from the gas entrance on the anode flow field plate. Since the cross-sectional area of the flowpath of this location is larger, the flowing speed of the fuel gases is not high, and the protons can easily reach the cathode flow field plate through the proton-exchange membrane. As the water generated by the reaction between the fuel gases and the oxidant gases accumulates, most water is generated at the gas exit on the cathode flow field plate. Here, the cross-sectional area of the flowpath is smaller and the flowing speed of the gases is higher, thus more water can be carried away, clearing the channels and preventing water from accumulating.

The following embodiments will further illustrate this invention.

### Embodiment 1

This embodiment provides a type of flow field plate having a consistent number of channels with a consistent depth and an inconsistent width. The width of the flowpaths on the flow field plates varies in a linear fashion.

The cathode flow field plate 1 and the anode flow field plate 2 as shown in FIG. 2 can be made of graphite material. Each of the flow field plates has a gas entrance 9 and a gas exit 10. The length, width, and depth of the flow field plates can be 120 mm, 80 mm and 1.5 mm respectively.

In this embodiment, the flowpath 8 of the flow field is a single channel. The flowpath 8 is of a pectinate shape. The width of flowpath 8 is gradually reduced from the gas entrance 9 to the gas exit 10. The width of the flowpath can be reduced by 0.1 mm in a linear fashion. For example, the width of the first length of the flowpath at the gas entrance can be 3 mm, the width of the second length can be 2.9 mm, the width of the third length can be 2.8 mm, and the width of the flowpath at the gas exit is the narrowest, being 1.1 mm. But the depth of the flowpath is consistently 0.6 mm, and the width of plate ribs 11 are consistently 1 mm.

### Embodiment 2

This embodiment provides a type of flow field plate having a consistent number of channels with a consistent width and a flowpath with an inconsistent depth. The depth of the flowpaths on the flow field plates changes in a linear fashion.

The cathode flow field plate 1 and the anode flow field plate 2 as shown in FIG. 3 can be made of graphite material. Each of the flow field plates has a gas entrance 9 and a gas exit 10. The length, width, and depth of the flow field plates can be 60 mm, 60 mm and 2.5 mm respectively.

In this embodiment, the flowpath 8 of the flow field plate is a single channel. The width of the flowpath 8 can be consistently 2 mm, and the thickness of plate ribs 11 can be consistently 1 mm. The width of the flowpath 8 can be gradually reduced from the gas entrance 9 to the gas exit 10. The depth of the flowpath at the gas entrance can be 1.5 mm, and the depth of the flowpath at the gas exit can be 0.3 mm. The depth can decrease by a rate of −1.63 mm/m from the gas entrance to the gas exit.

### Embodiment 3

This embodiment provides a type of flow field plate having a flowpath of a consistent width and depth and a varying number of channels. The cross section of the flowpaths on the flow field plates changes in a nonlinear fashion.

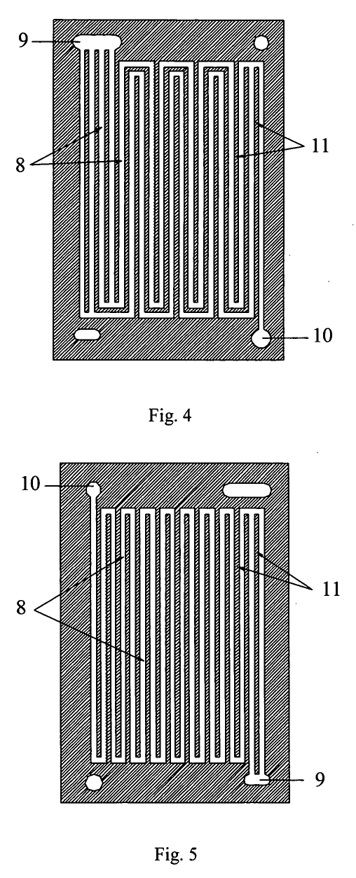

In fabricating the cathode flow field plate I for fuel cells as shown in FIG. 4, here, the entering portion (i.e., the entering area at the gas entrance making up ⅓ of the total length or area of the flowpath, same as follows) of the flowpath in the cathode flow field plate 1 comprises of four parallel channels, and the flowpath is reduced to two channels at the middle portion (i.e., the middle area making up ⅓ of the total length or area of the flowpath, same as follows), and the flowpath is reduced to one channel at the end portion (i.e., the end length or area making up ⅓ of the total length or area of the flowpath, same as follows). The widths of the channels for the entering portion, the middle portion and the end portion are all 2 mm, and the depths are all 0.8 mm. The thickness of plate ribs 11 between channels are all 1.5 mm. Other than the above mentioned measurements, the features of the cathode flow field plate 1 are identical to those of Embodiment 1.

In fabricating the anode flow field plate 2 as shown in FIG. 5, here, the entering portion of the flowpath in the anode flow field plate 2 comprises of two parallel channels, and the flowpath is reduced to one channel at the middle portion. Since no water is generated in the reactions at the anode flow field plate 2 and the amount of gas flow is relatively small, the end portion of the flowpath will not be reduced and remains to be one channel. The widths of the channels for the entering portion, the middle portion and the end portion are all 2 mm, and the depths are all 0.6 mm. The thickness of plate ribs 11 between channels is all 1.5 mm. Other than the above mentioned measurements, the features of the anode flow field plate 2 are identical to those of Embodiment 1.

While the descriptions have been provided in describing the flowpath being viewed as three portions (each have a particular length), it shall be understood that the flowpath can be viewed as two portions (with a first length and a second length) or more than three portions and the present invention can be equally applied to these various embodiments.

Further note that an anode can also be referred to as a positive electrode, and a cathode can also be referred to as a negative electrode.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A flow field plate for fuel cells, the flow field plate having a flowpath, an entrance to the flowpath, and an exit to the flowpath, wherein the entrance has a first cross-sectional area and the exit has a second cross-section area, and wherein the first cross-sectional area is larger than the second cross-sectional area.

2. The flow field plate for fuel cells of claim 1 wherein the flowpath, for a first length, maintains the first cross-sectional area, and then the cross-sectional area of the flowpath is reduced to have the second cross-sectional area.

3. The flow field plate for fuel cells of claim 2 wherein the flowpath, for a first length, maintains the first cross-sectional area, and then, for a second length, maintains the second cross-sectional area.

4. The flow field plate for fuel cells of claim 2 wherein the flowpath has a width and a depth, and the depth of the flowpath is maintained.

5. The flow field plates for fuel cells of claim 2 wherein the flowpath has a width and a depth, and the width of the flowpath is maintained.

6. The flow field plate for fuel cells of claim 5 wherein the flowpath has a width and a depth, and the depth of the flowpath is maintained.

7. The flow field plate for fuel cells of claim 1 wherein the flowpath has two or more channels at a portion of the flowpath.

8. The flow field plate for fuel cells of claim 7 wherein the flowpath has a plurality of channels for a first length at the entrance of the flowpath and one or more channels for a second length at the exit of the flowpath.

9. The flow field plate for fuel cells of claim 8 wherein each of the channels of the flowpath have a first cross-sectional area at the entrance of the flowpath and a second cross-sectional area at the exit of the flowpath, wherein the first cross-sectional area is maintained for a first length in the flowpath and the channels are then reduced to have the second cross-sectional area.

10. The flow field plate for fuel cells of claim 9 wherein the channels for a first length has the first cross-sectional area and is then reduced to have the second cross-sectional area; and the channels, for a second length, are maintained to have the second cross-sectional area.

11. The flow field plate for fuel cells of claim 9 wherein each of the channels has a width and a depth and the depth of at least one of the channels of the flowpath is maintained.

12. The flow field plate for fuel cells of claim 9 wherein each of the channels has a width and a depth and the width of at least one of the channels of the flowpath is maintained.

13. The flow field plate for fuel cells of claim 12 wherein each of the channels has a width and a depth and the depth of at least one of the channels of the flowpath is maintained.

14. A flow field plate for fuel cells, said flow field plate having a flowpath, an entrance to the flowpath, and an exit to the flowpath, wherein the flowpath has a first cross-sectional area at the entrance of the flowpath and a second cross-sectional area at the exit of the flowpath, and the first cross-sectional area is larger than the second cross-sectional area, and wherein the flowpath, for a first length, maintains the first cross-sectional area and is then reduced to the second cross-sectional area.

15. The flow field plate for fuel cells of claim 14 wherein the flowpath, for a first length, maintains the first cross-sectional area, and then, for a second length, maintains the second cross-sectional area.

16. The flow field plate for fuel cells of claim 15 wherein the flowpath has a width and a depth, and the depth of the flowpath is maintained.

17. The flow field plates for fuel cells of claim 15 wherein the flowpath has a width and a depth, and the width of the flowpath is maintained.

18. The flow field plate for fuel cells of claim 17 wherein the flowpath has a width and a depth, and the depth of the flowpath is maintained.

19. A flow field plate for fuel cells, said flow field plate having a flowpath, an entrance to the flowpath, and an exit to the flowpath, wherein the cross-sectional area at the entrance is larger than the cross-sectional area at the exit; and the flowpath has a plurality of channels for a first length proximately disposed at the entrance of the flowpath and one or more channels for a second length proximately disposed at the exit of the flowpath.
